(19) United States
(12) Patent Application Publication
(10) Pub. No.: US 2010/0284897 A1
(43) Pub. Date: Nov. 11, 2010

(54) Apparatus and method for synthesizing carbon nanotube

(75) Inventors: Hyung- Joon Kim, Suwon-si (KR); Ho-Soo Hwang, Suwon-si (KR); Jung-Keun Cho, Seoul (KR)

Correspondence Address: HARNESS, DICKEY & PIERCE, P.L.C., P.O. BOX 8910, RESTON, VA, 20195, US

(73) Assignee: Semes CO., LTD.

(21) Appl. No.: 11/984,481

(22) Filed: Nov. 19, 2007

(30) Foreign Application Priority Data
Apr. 27, 2007 (KR) 10-2007-0041068

(51) Int. Cl. D01F 9/12; B01J 19/00

(52) U.S. Cl. 423/447.3; 422/198; 977/742; 977/842

(57) ABSTRACT

An apparatus for synthesizing a carbon nanotube includes a reaction chamber, a cassette, a transferring member, a heater, a gas supply member and a gas exhausting part. The carbon nanotube is synthesized in the reaction chamber. The reaction chamber has a substantially vertical major axis. The cassette holds a plurality of substrates. The transferring member transfers the cassette along a direction substantially in parallel relative to the major axis to load/unload the cassette into/from the reaction chamber. The heater heats the reaction chamber. The gas supply member provides the reaction chamber with a gas for synthesizing the carbon nanotube. The gas exhausting member exhausts a remaining gas from the reaction chamber. Collecting the carbon nanotube may be facilitated and managing the reaction chamber may be effective to enhance a productivity of the carbon nanotube.

### CROSS-REFERENCE TO RELATED APPLICATION

This application claims priority under 35 USC §119 to Korean Patent Application No. 2007-41068 filed on Apr. 27, 2007, the contents of which are herein incorporated by reference in their entirety.

### BACKGROUND OF THE INVENTION

1. Field of the Invention

Example embodiments of the present invention relates to an apparatus and a method of synthesizing a carbon nanotube. More particularly, example embodiments of the present invention relates to an apparatus and a method of synthesizing carbon nanotube at a high temperature.

2. Description of the Related Art

A carbon nanotube (CNT), which is a kind of a carbon allotrope, includes carbon atoms combined to form a honeycomb structure or a hexagonal prism structure. The carbon nanotube generally has a diameter of a few nanometers (nm). The carbon nanotube has merits such as good mechanical characteristics, electrical selectivities, field emission characteristics, highly efficient hydrogen-storing media characteristics, etc. Therefore, the carbon nanotube may be employed in various industrial fields such as an aerospace industry, a biotechnology, an environmental engineering, a material science, medical fields, electronics, etc.

To synthesize the carbon nanotube, an electric discharge process, a plasma chemical vapor deposition (CVD) process, a thermal CVD process or a thermal decomposition process have been developed. Recently, the thermal CVD process and the thermal decomposition process are commercially suitable for mass production.

FIG. 1 is a cross-sectional view illustrating a conventional apparatus for synthesizing a carbon nanotube.

Referring to FIG. 1, the conventional apparatus for synthesizing the carbon nanotube includes a reaction chamber 10, a heater 20, a peripheral device 30, a standby chamber 60 and a transferring member 70.

The reaction chamber 10 has a cylindrical shape. Additionally, the reaction chamber 10 has a major axis horizontally disposed with respect to a ground.

The heater 20 encloses the reaction chamber 10 to heat the reaction chamber 10. The heater 20 includes, for example, a heating coil that surrounds the reaction chamber 10. The heater 20 heats the reaction chamber 10 to a temperature of about 1,000° C.

Although not shown in FIG. 1, the reaction chamber 10 has a structure that receives a gas through a first side, and exhausts the gas through a second side opposite to the first side. When the gas is provided into the reaction chamber 10 heated by the heater 20, a carbon nanotube is synthesized on a substrate 220 loaded in the reaction chamber 10.

The standby chamber 60 is disposed adjacent to the first side of the reaction chamber 10. The transferring member 70 transfers the substrate 220 from the standby chamber 60 to the reaction chamber 10, or transfers the substrate 220 having the carbon nanotube generated thereon from the reaction chamber 10 to the standby chamber 60.

The peripheral device 30 is disposed adjacent to the standby chamber 60. The peripheral device 30 includes a retrieving member for retrieving the substrate 220 having the carbon nanotube generated thereon from the standby chamber 60, a catalyst applicator for applying a catalyst onto the substrate 220 loaded from the standby chamber 60 into the reaction chamber 10.

The apparatus for synthesizing the carbon nanotube shown in FIG. 1, a plurality of substrates are stacked in the reaction chamber 10. As the reaction chamber 10 increases in a size, a stroke of the transferring member 70 also increases so that the transferring member 70 may sag. Additionally, when carbon nanotubes are excessively synthesized on the substrates, or when the substrates having the carbon nanotubes generated thereon are transferred to the standby chamber 60 by the transferring member 70, the carbon nanotubes may be dropped onto a bottom of the reaction chamber 10. Therefore, an additional process and time for cleaning the reaction chamber to prevent a malfunction of the apparatus are required, thereby reducing productivity.

### SUMMARY OF THE INVENTION

Example embodiments of the present invention provide an apparatus for synthesizing a carbon nanotube (CNT), which is capable of facilitating retrieval of the carbon nanotube, increasing an efficiency of managing a reaction chamber and enhancing a productivity of the carbon nanotube.

Example embodiments of the present invention also provide a method of synthesizing a carbon nanotube using the apparatus.

According to one aspect of the present invention, there is provided an apparatus for synthesizing a carbon nanotube includes a reaction chamber, a cassette, a transferring member, a heater, a gas supply member and a gas exhausting member. The carbon nanotube is synthesized in the reaction chamber. The reaction chamber has a substantially vertical major axis. The cassette holds a plurality of substrates. The substrates may be stacked in the cassette. The transferring member transfers the cassette along a direction substantially in parallel relative to the major axis so as to load the cassette into the reaction chamber or unload the cassette from the reaction chamber. The heater heats the reaction chamber. The gas supply member provides the reaction chamber with a gas for synthesizing the carbon nanotube. The gas exhausting member exhausts a remaining gas from the reaction chamber.

In example embodiments, the gas supply member may provide the reaction chamber with the gas through an upper portion of the reaction chamber. The gas exhausting member may exhaust the remaining gas through a lower portion of the reaction chamber.

In example embodiments, the reaction chamber may include an outer housing and an inner housing disposed in the outer housing. The inner housing may include a plurality of gas injection holes so that the gas passing the injection holes flows into the inner housing. The gas injection holes may be arranged along a direction substantially perpendicular to the major axis of the reaction chamber.

In an example embodiment, the heater may enclose the outer housing of the reaction chamber.

In example embodiments, the substrates may be stacked in the reaction chamber along a direction substantially in parallel with respect to the major axis of the reaction chamber.

In example embodiments, the gas supply member may include a hydrogen gas reservoir, an inactive gas reservoir and a carbon source gas reservoir.

In an example embodiment, the apparatus may additionally include a pressure adjusting member for controlling a pressure of the reaction chamber.

In example embodiments, the apparatus may additionally include a standby chamber disposed under the reaction chamber wherein the cassettes locates in the standby chamber before loading into the reaction chamber or after unloading from the reaction chamber. The standby chamber may include a door through which the substrates are loaded into the standby chamber or unloaded from the standby chamber.

In an example embodiment, the apparatus may further include a transferring robot disposed adjacent to the door to load the substrates into the standby chamber or to unload the substrates from the standby chamber.

In an example embodiment, the apparatus may additionally include a cleaning apparatus for cleaning carbon nanotubes generated on the substrates.

According to another aspect of the present invention, there is provided a method of synthesizing a carbon nanotube. In the method of synthesizing the carbon nanotube, a catalyst metal powder may be placed on a plurality of substrates. The substrates may be inserted into a cassette. After loading the cassette into a reaction chamber having a substantially vertical major axis, a gas for synthesizing the carbon nanotube may be provided into the reaction chamber while heating the reaction chamber.

In example embodiments, the substrates may be stacked in the cassette along a direction substantially in parallel relative to the major axis of the reaction chamber.

In a process for providing the gas for synthesizing the carbon nanotube, a reducing gas may be provided into the reaction chamber to reduce the catalyst metal powder, and then a carbon source gas for synthesizing the carbon nanotube may be provided into the reaction chamber. The reducing gas may include a hydrogen gas, and the carbon source gas may include a hydrocarbon gas.

In example embodiments, an inactive gas and a hydrogen gas may be provided into the reaction chamber while providing the gas for synthesizing the carbon nanotube.

In example embodiments, the catalyst metal powder may include transition metal.

In example embodiments, the reaction chamber may be heated to a temperature of about 600° C. to about 1,200° C.

According to still another aspect of the present invention, there is provided a method of synthesizing a carbon nanotube. In the method of synthesizing the carbon nanotube, a catalyst metal powder may be reduced to generate a reduced catalyst metal powder. The reduced catalyst metal powder may be placed on a substrate. After inserting the substrate into a cassette, the cassette may be loaded into a reaction chamber having a substantially vertical major axis. A gas for synthesizing the carbon nanotube may be provided into the reaction chamber while heating the reaction chamber.

According to example embodiments of the present invention, a reaction chamber may be vertically disposed and a standby chamber may be disposed under the reaction chamber. Therefore, collecting a carbon nanotube on a substrate may be facilitated and managing of the reaction chamber may be effective to enhance a productivity of the carbon nanotube.

### BRIEF DESCRIPTION OF THE DRAWINGS

The above and other features and advantages of the present invention will become more apparent by describing in detailed example embodiments thereof with reference to the accompanying drawings, in which:

FIG. 1 is a cross-sectional view illustrating a conventional apparatus for synthesizing a carbon nanotube (CNT);

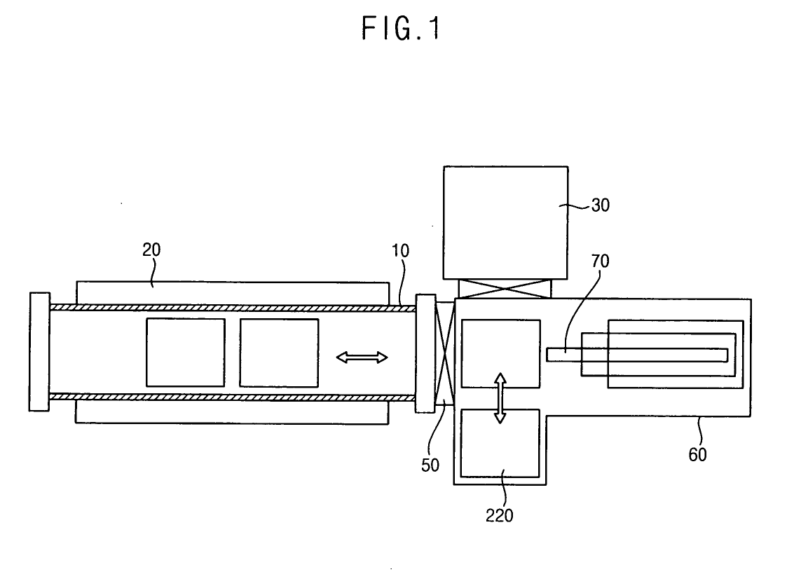

FIG. 2 is a cross-sectional view illustrating an apparatus for synthesizing a carbon nanotube in accordance with example embodiments of the present invention;

FIG. 3 is a partially cut perspective view illustrating the apparatus for synthesizing the carbon nanotube in FIG. 2; and

FIG. 4 is a perspective view illustrating an inner housing of the apparatus for synthesizing the carbon nanotube in FIG. 2.

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the example embodiments set forth herein. Rather, these example embodiments are provided so that this disclosure will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Apparatus for Synthesizing Carbon Nanotube

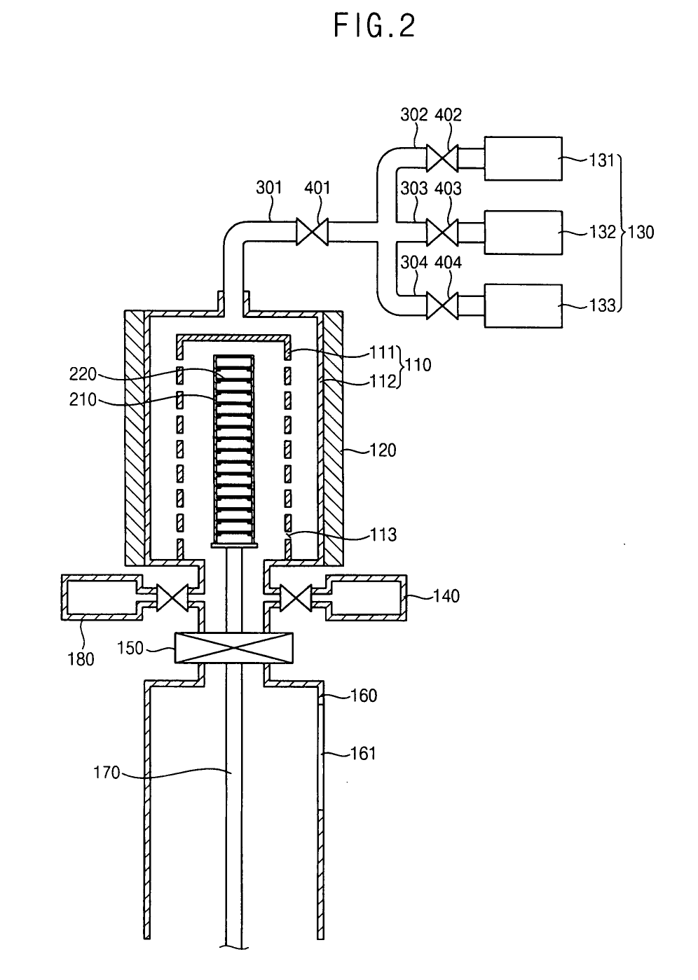

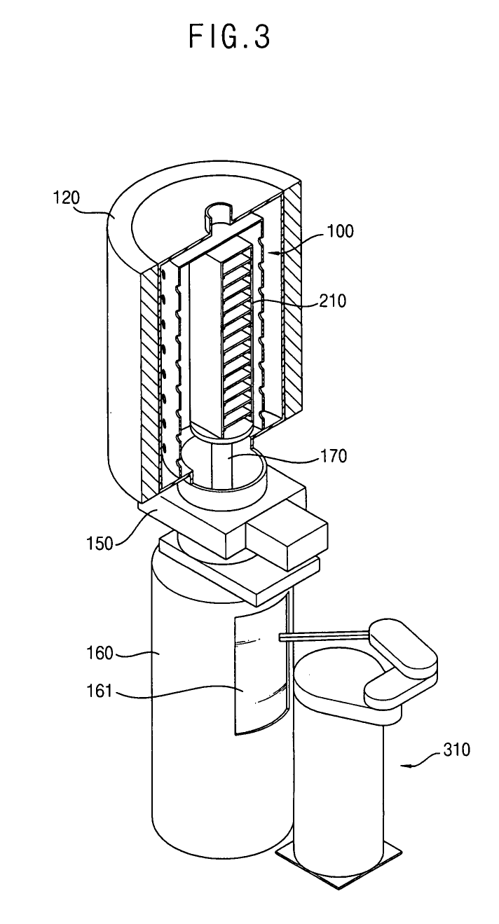

FIG. 2 is a cross-sectional view illustrating an apparatus for synthesizing a carbon nanotube (CNT) in accordance with example embodiments of the present invention. FIG. 3 is a partially cut perspective view illustrating the apparatus in FIG. 2.

Referring to FIGS. 2 and 3, the apparatus for synthesizing the carbon nanotube includes a reaction chamber 110, a cassette 210, a transferring member 170, a heater 120, a gas providing member 130 and a gas exhausting member 140.

The reaction chamber 110 may have a hollow polygonal pillar shape, a cylindrical shape, etc. A major axis of the reaction chamber 110 may be substantially perpendicular to a ground whereas a minor axis of the reaction chamber 110 may be substantially in parallel to the ground. That is, the reaction chamber 110 may have a substantially vertical major axis. A cross-section of the reaction chamber 110 may have a circular shape or a polygonal shape such as a rectangular shape, a hexagonal shape, etc.

In some example embodiments, the reaction chamber 110 includes an inner housing 111 and an outer housing 112. The inner housing 111 and the outer housing 112 may be integrally formed together. Alternatively, the inner housing 111 and the outer housing 112 may be separately prepared each other. The inner housing 111 of the reaction chamber 110 may be positioned at an inside of the outer housing 112.

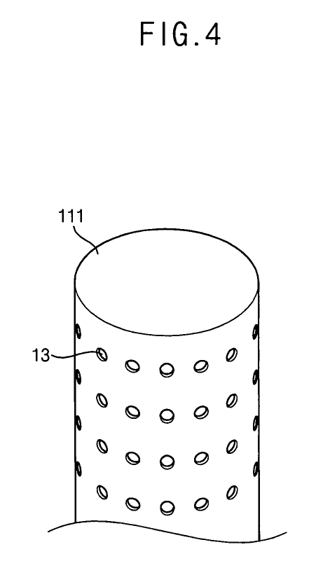

When the reaction chamber 110 includes the inner housing 111 and the outer housing 112, a gas may be uniformly provided onto a plurality of substrates 220 loaded in the cassette 210 disposed in the reaction chamber 110. The inner housing 111 includes a plurality of gas injection holes 113 for uniformly providing the gas onto the substrates 220. The gas injection holes 113 may be positioned substantially in parallel relative to the substrates 220 loaded in the cassette 220. A construction and a function of the reaction chamber 110 will be described in detail with reference to FIG. 4.

The cassette 210 holds the substrates 220. For example, the substrates 220 may be inserted into the cassette 210 along a direction substantially perpendicular to the major axis of the reaction chamber 110. Additionally, the substrates 220 may be vertically stacked in the cassette 210. The substrates 220 in the cassette 210 are loaded into the reaction chamber 110. The cassette 210 may include, for example, quartz, graphite, etc.

Each of the substrates 220 may include, for example, a silicon substrate, an indium tin oxide (ITO) substrate, an ITO-coated glass substrate, a soda-lime glass substrate, etc. Alternatively, the substrates 220 may include other materials as long as the substrates 220 have enough mechanical strength when the carbon nanotube is synthesized.

The transferring member 170 transfers the cassette 210 along an upward direction relative to the reaction chamber 110 such that the substrates 220 are loaded into the reaction chamber 110. Additionally, the transferring member 170 moves downwardly, thereby unloading the substrate 220 from the reaction chamber 110. The cassette 210 may be disposed on an end of the transferring member 170.

The heater 120 applies a heat to the reaction chamber 110. The heater 120 may enclose the outer housing of the reaction chamber 110. The heater 120 may heat the reaction chamber 110 to a predetermined temperature. For example, the reaction chamber 110 may be heated at a temperature of about 600° C. to about 1,200° C. In an example embodiment, a furnace may be employed in the apparatus as the heater 120.

The gas supply member 130 provides the reaction chamber 110 with a gas. The gas may be supplied into the reaction chamber 110 through an upper portion of the reaction chamber 110. Alternatively, the gas supply member 130 may provide the gas into the reaction chamber 110 through a lateral portion or a lower portion of the reaction chamber 110.

In some example embodiments, the gas supply member 130 may include a hydrogen gas reservoir 131, an inactive gas reservoir 132 and a carbon source gas reservoir 133.

The hydrogen gas, the inactive gas and the carbon source gas reservoirs 131, 132 and 133 are connected to a first pipe 301. In other words, the first pipe 301 is divided into a second pipe 302, a third pipe 303 and a fourth pipe 304. The hydrogen gas reservoir 131 is connected to the first pipe 301 through the second pipe 302. The inactive reservoir 132 is connected to the first pipe 301 through the third pipe 303. The carbon source gas reservoir 133 is connected to the first pipe 301 through the fourth pipe 304. The first pipe 301 is also connected to the upper portion of the reaction chamber 110.

A first valve 401 is installed in the first pipe 301, and a second valve 402 is installed in the second pipe 302. Further, the third pipe 303 has a third valve 403 and the fourth pipe 304 has a fourth valve 404.

The first valve 401 may control a flow rate of a gas mixture including a hydrogen gas from the hydrogen gas reservoir 131, an inactive gas from the inactive gas reservoir 132, and a carbon source gas from the carbon source reservoir 133. The second, the third and the fourth valves 402, 403 and 404 may adjust the composition of the gas mixture. That is, concentrations of the hydrogen gas, the inactive gas and the carbon source gas in the gas mixture may be controlled by the second, the third and the fourth valves 402, 403 and 404. The carbon source gas may include a hydrocarbon gas.

In one example embodiment, the second pipe 302 having the second valve 402, the third pipe 303 having the third valve 403 and the fourth pipe 304 having the fourth valve 404 are connected to the reaction chamber 110 through the first pipe 301 as illustrated in FIG. 2. In another example embodiment, the second pipe 302 having the second valve 402, the third pipe 303 having the third valve 403 and the fourth pipe 304 having the fourth valve 404 may be directly connected to the reaction chamber 110.

When the cassette 210 including the substrates 220 having catalyst metal powder disposed thereon is loaded into the reaction chamber 110, the first valve 401 and the second valve 402 are opened, so that the hydrogen gas is injected on the substrates 220 in the reaction chamber 110 from the hydrogen gas reservoir 131.

Since the heater 120 heats the reaction chamber 110 to the temperature of about 600° C. to about 1,200° C., the hydrogen gas reacts with the catalyst metal powder to reduce the catalyst metal and to generate water vapor. The water vapor may be exhausted from the reaction chamber 110 through the lower portion of the reaction chamber 110. For example, the water vapor may be exhausted through an outlet (not illustrated) connected to the lower portion of the reaction chamber 110.

When the third and the fourth valves 403 and 404 are opened, the inactive gas and the carbon source gas are provided into the reaction chamber 110. Carbon separated from the carbon source gas may be absorbed onto the reduced catalyst metal so that the carbon nanotubes may grow on the substrates 220, respectively.

The gas exhausting member 140 exhausts a remaining gas from the reaction chamber 110 and the pressure adjusting member 180 controls a pressure of the reaction chamber 110.

In some example embodiments, the apparatus for synthesizing the carbon nanotube may further include a standby chamber 160. The standby chamber 160 may be disposed under the reaction chamber 110. The substrates 220 may locate in the standby chamber 160 before the substrates 220 are loaded into the reaction chamber 110 or after the substrates 220 are unloaded from the reaction chamber 110

The standby chamber 160 may include a door 161. Additionally, the apparatus may further include a transferring robot 310 disposed adjacent to the door 161 of the standby chamber 160. The transferring robot 310 may load the substrates 220 into the standby chamber 160, or may unload the substrates 220 having the carbon nanotubes formed thereon from the standby chamber 160.

A gate valve 150 may be installed between the standby chamber 160 and the reaction chamber 110 to open the reaction chamber 110 or close the reaction chamber 110.

FIG. 4 is a partial perspective view illustrating the inner housing 111 of the reaction chamber 110 in FIG. 2.

Referring to FIGS. 2 and 4, the reaction chamber 110 includes the inner housing 111 and the outer housing 112. The inner housing 111 is disposed in the inside of the outer housing 112. The inner housing 111 includes the plurality of gas injection holes 113. The gas injection holes 113 may be arranged along the direction substantially perpendicular to the major axis of the reaction chamber 110. The gas injection holes 113 may be formed through a circumferential portion of the reaction chamber 110. Thus, the substrates 220 loaded in the reaction chamber 110 may be surrounded by the gas injection holes 113. Alternatively, an arrangement of the gas injection holes 113 may vary as occasion demands.

When the gas is provided into the reaction chamber 110 through the first pipe 301 from the gas supply member 130, the gas is injected into a space between the outer and the inner housings 112 and 111. Then, the gas is supplied into the inner housing 111 through the gas injection holes 113. Therefore, the gas may uniformly react with the catalyst metal powder on the substrates 220 disposed in the lower and the upper portions of the reaction chamber 110.

Method of Synthesizing Carbon Nanotube

Hereinafter, a method of synthesizing the carbon nanotube using the apparatus described with reference to FIGS. 2 to 4 will be described in detail.

The substrates 220 serving as bases for synthesizing the carbon nanotube are prepared. The substrates 220 may include silicon substrates, ITO substrates, ITO-coated glass substrates or soda-lime glass substrates, respectively. Each of the substrates 220 may include other material as long as the substrates 220 have enough mechanical strength while synthesizing the carbon nanotubes on the substrates 220.

In some example embodiments, the substrates 220 may be loaded into a cleaning apparatus (not illustrated) after the substrates 220 are prepared. The substrates 220 may be cleaned using a cleaning gas or a cleaning solution in the cleaning apparatus. For example, an inactive gas may be employed as the cleaning gas.

The catalyst metal powder is placed on the substrates 220. The catalyst metal powder may include a transition metal. For example, the catalyst metal powder may include iron (Fe), nickel (Ni), etc.

The substrates 220 having the catalyst metal powder disposed thereon are transferred to the cassette 210 in the standby chamber 160 through the door 161 using the transferring robot 310. The transferring member 170 may upwardly elevate the cassette 210 to the reaction chamber 110. That is, the transferring member 170 may transfer the cassette 210 having the substrates 220 along a direction substantially in parallel relative to the major axis of the reaction chamber 110.

The gate valve 150 is closed, and the first and second valves 401 and 402 are opened to provide the reaction chamber 110 with a hydrogen gas from the hydrogen gas reservoir 131.

The heater 120 may heat the reaction chamber 110 to a temperature of about 600° C. to about 1,200° C. As a result, the hydrogen gas reacts with the catalyst metal powder to generate water vapor. The water vapor may be exhausted from the reaction chamber 110 through the lower portion of the reaction chamber 110.

The third and fourth valves 403 and 404 are opened to provide the reaction chamber 110 with an inactive gas and a carbon source gas. The inactive gas may include a helium gas, a neon gas, an argon gas, a nitrogen gas, etc. Additionally, the carbon source gas may include a hydrocarbon gas. Carbon separated from the carbon source gas may be absorbed onto the catalyst metal powder and grows to form the carbon nanotubes on the substrates 220.

When the reaction for generating the carbon nanotubes is completed, the gate valve 150 is opened, and the transferring member 170 moves the cassette 210 toward the standby chamber 160.

The door 161 of the standby chamber 160 is opened and the substrates 220 are unloaded from the standby chamber 160 by the transferring robot 310.

In some example embodiment, an additional process such as a cleaning process may be performed on the carbon nanotubes synthesized on the substrates 220.

The carbon nanotubes are separated from the substrates 220, and then collected by a post-processing apparatus (not illustrated), thereby synthesizing the carbon nanotubes.

As described above, the process for reducing the catalyst metal powder and the process for synthesizing the carbon nanotube may be successively performed in the reaction chamber 110. However, the process for reducing the catalyst metal powder may be performed in a reduction chamber (not illustrated) and the substrates 220 having the reduced catalyst metal powder disposed thereon may be loaded into the reaction chamber 110. In other words, only the process for synthesizing the carbon nanotube may be performed in reaction chamber 110.

According to the present invention, a reaction chamber may be substantially vertically disposed and a standby chamber may be disposed under the reaction chamber. Thus, collecting the carbon nanotube may be facilitated and managing of the reaction chamber may be effective to enhance a productivity of the carbon nanotube.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. An apparatus for synthesizing a carbon nanotube, comprising:
a reaction chamber having a substantially vertical major axis;
a cassette holding a plurality of substrates;
a transferring member transferring the cassette along a direction substantially in parallel relative to the major axis, to load the cassette into the reaction chamber or to unload the cassette from the reaction chamber;
a heater for heating the reaction chamber;
a gas supply member for providing the reaction chamber with a gas for synthesizing the carbon nanotube; and
a gas exhausting member for exhausting a remaining gas from the reaction chamber.

2. The apparatus of claim 1, wherein the gas supply member provides the reaction chamber with the gas through an upper portion of the reaction chamber, and the gas exhausting member exhausts the remaining gas through a lower portion of the reaction chamber.

3. The apparatus of claim 2, wherein the reaction chamber comprises:
an outer housing; and
an inner housing disposed in the outer housing, the inner housing including a plurality of gas injection holes so that the gas passing the injection holes flows into the inner housing.

4. The apparatus of claim 3, wherein the gas injection holes are arranged along a direction substantially perpendicular to the major axis of the reaction chamber.

5. The apparatus of claim 3, wherein the heater encloses the outer housing of the reaction chamber.

6. The apparatus of claim 3, wherein the substrates are stacked in the reaction chamber along a direction substantially in parallel with respect to the major axis of the reaction chamber.

7. The apparatus of claim 1, wherein the gas supply member comprises:
a hydrogen gas reservoir;
an inactive gas reservoir; and
a carbon source gas reservoir.

8. The apparatus of claim 1, further comprising a pressure adjusting member for controlling a pressure of the reaction chamber.

9. The apparatus of claim 1, further comprising a standby chamber disposed under the reaction chamber wherein the cassettes locates in the standby chamber before loading into the reaction chamber or after unloading from the reaction chamber.

10. The apparatus of claim 9, wherein the standby chamber includes a door through which the substrates are loaded into the standby chamber or unloaded from the standby chamber.

11. The apparatus of claim 10, further comprising a transferring robot disposed adjacent to the door to load the substrates into the standby chamber or to unload the substrates from the standby chamber.

12. The apparatus of claim 1, further comprising a cleaning apparatus for cleaning carbon nanotubes generated on the substrates.

13. A method of synthesizing a carbon nanotube, comprising:
placing a catalyst metal powder on a plurality of substrates;
inserting the substrates into a cassette;
loading the cassette into a reaction chamber having a substantially vertical major axis; and
providing a gas for synthesizing the carbon nanotube into the reaction chamber while heating the reaction chamber.

14. The method of claim 13, wherein the substrates are stacked in the cassette along a direction substantially in parallel relative to the major axis of the reaction chamber.

15. The method of claim 13, wherein providing the gas for synthesizing the carbon nanotube comprises:
providing a reducing gas into the reaction chamber to reduce the catalyst metal powder; and
providing a carbon source gas for synthesizing the carbon nanotube into the reaction chamber.

16. The method of claim 15, wherein the reducing gas includes a hydrogen gas and the carbon source gas includes a hydrocarbon gas.

17. The method of claim 15, wherein providing the gas for synthesizing the carbon nanotube further comprises providing an inactive gas and a hydrogen gas into the reaction chamber.

18. The method of claim 15, wherein the catalyst metal powder comprises transition metal.

19. The method of claim 15, wherein the reaction chamber is heated to a temperature of about 600° C. to about 1,200° C.

20. A method of synthesizing a carbon nanotube, comprising:
reducing a catalyst metal powder to generate a reduced catalyst metal powder;
placing the reduced catalyst metal powder on a substrate;
inserting the substrate into a cassette;
loading the cassette into a reaction chamber having a substantially vertical major axis; and
providing a gas for synthesizing the carbon nanotube into the reaction chamber while heating the reaction chamber.
